(19) United States
(12) Patent Application Publication
(10) Pub. No.: US 2026/0310553 A1
(43) Pub. Date: Oct. 8, 2026

(54) METHODS AND SYSTEMS FOR OFFLOADING MEMORY DATA RECONSTRUCTION

(71) Applicant: SK Hynix NAND Product Solutions Corp. (dba Solidigm), Rancho Cordova, CA (US)

(72) Inventor: George KALWITZ, Mead, CO (US)

(21) Appl. No.: 19/173,655

(22) Filed: Apr. 8, 2025

(51) Int. Cl. G06F 11/10

(52) U.S. Cl. CPC G06F 11/1088; G06F 11/108

(57) ABSTRACT

This application is directed to managing data construction in a memory system having a plurality of memory drives that further include a set of member drives and a target drive. The memory system obtains a structured data command and extracts the identifications of the member drives from the structured data command. Based on the identifications of the member drives, the memory system generates at least one data request sent to each member drive. In response to the at least one data request to each member drive, the memory system obtains a respective data chunk extracted from the respective member drive, generates a target data chunk based on respective data chunks extracted from the set of member drives, and stores the target data chunk on a target drive. The structured data command may be obtained and processed by the target drive to generate the data requests and the target data chunk.

### TECHNICAL FIELD

This application relates generally to memory technology including, but not limited to, methods, systems, and devices for managing data construction locally in a memory system coupled to a host device.

### BACKGROUND

Memory is applied in a computer system to store instructions and data. The data are processed by one or more processors of the computer system according to the instructions stored in the memory. Multiple memory units are used in different portions of the computer system to serve different functions. Specifically, the computer system includes non-volatile memory that acts as secondary memory to keep data stored thereon if the computer system is decoupled from a power source. Examples of the secondary memory include, but are not limited to, hard disk drives (HDDs) and solid-state drives (SSDs). The secondary memory relies on a memory controller to manage its memory space and process read, write, and read-modify-write requests from a host device. Data are sometimes stored as stripes on secondary memory, with each stripe divided into multiple data chunks that are distributed across several memory drives. When a drive in the secondary memory fails, the system must investigate its metadata to identify the lost data chunks, collaborate with the host device to reconstruct them, and restore the reconstructed data chunks on the remaining operational drives. Typically, the secondary memory focuses on storage functions and relies on the host device to reconstruct the lost data chunks. This process involves intensive communication between the host and secondary memory, making data reconstruction both expensive and inefficient.

### SUMMARY

Various embodiments of this application are directed to methods, memory systems, and memory devices for reconstructing data lost on one of a plurality of memory drives of a memory system (also called a storage system) locally on the memory system. Examples of the memory system include an SSD memory system made of a plurality of NAND flash memory drives. A target data chunk is lost on a first memory drive, and reconstructed on a target drive based on a set of data chunks of a set of member drives associated with the first memory drive. In some embodiments, the set of data chunks and the target data chunk are related to one another and form a stripe of data. The set of data chunks are communicated between the set of member drives and the target drive without involving a host device as an intermediary. Stated another way, the host device may offload reconstruction of the target data chunk lost on the first memory device to the memory system itself. In an example, the target data chunk includes Reed-Solomon error codes determined based on the set of data chunks of the set of member drives, and reconstruction of the target data chunk, if implemented on the memory system, may be simplified compared with reconstruction implemented by the host device.

In some embodiments, reconstruction of multiple lost chunks of a failed drive may be scalable with a number of memory drives included in the memory system, and particularly, applicable in a large-scale memory erasure system that is configured to distribute parity data (also called integrity data) across multiple memory drives, typically in a distributed or enterprise-level environment. Reconstructing a single chunk engages a single target drive. When a drive fails, all the lost chunks must be reconstructed. The scalability comes from engaging multiple target drives simultaneously.

In one aspect, a method is implemented by a memory system to reconstruct data. The memory system includes a plurality of memory drives (e.g., solid-state drives (SSDs)), and the plurality of memory drives further include a set of member drives and a target drive distinct from each of the set of member drives. The method includes obtaining a structured data command including identifications of the set of member drives, and extracting the identifications of the set of member drives from the structured data command. The method further includes, based on the identifications of the set of member drives, generating at least one data request sent to each of the set of member drives (e.g., via a peer-to-peer communication channel). The method further includes, in response to the at least one data request sent to each member drive, obtaining a respective data chunk extracted from the respective member drive, generating a target data chunk based on respective data chunks extracted from the set of member drives, and storing the target data chunk on the target drive.

In some embodiments, the structured data command is obtained and processed by the target drive to generate the data requests and the target data chunk. In some embodiments, the structured data command is obtained and processed by the memory system on a system level to generate the data requests and the target data chunk. In some embodiments, the structured data command is obtained and processed by a combination of system-level firmware and drive-level firmware to generate the data requests and the target data chunk.

In some embodiments, the structured data command further includes an identification of the target drive and a target chunk address on the target drive. The method further includes identifying the target drive based on the identification of the target drive. The target data chunk is stored on the target drive based on the target chunk address. In some embodiments, the structured data command further includes a set of member chunk addresses on the set of member drives. For each of the set of member drives, the at least one data request includes a respective member chunk address of the respective member drive, and the respective data chunk is extracted from the respective member drive based at the respective member chunk address.

In some embodiments, the target data chunk corresponds to a parity data chunk (e.g., the single parity data chunk in a data stripe, one of multiple parity data chunks in a data stripe), and the respective data chunks extracted from the set of member drives correspond to a plurality of user data chunks. The plurality of user data chunks and the parity data chunk form a data stripe.

In another aspect, a method is implemented by a memory system to reconstruct data. The memory system includes a plurality of memory drives, and the plurality of memory drives further includes a target drive. The method includes obtaining a structured data command including an identification of a target drive, a target chunk address on the target drive, identifications of a set of member drives, a set of member chunk addresses on the set of member drives, and a reconstruction algorithm indicator. The method further includes identifying the target drive based on the identification of the target drive, reconstructing a target data chunk by the target drive, and stores the target data chunk on the target drive based at the target chunk address. Reconstruction of the target data chunk by the target drive further includes obtaining the identifications of the set of member drives and the set of member chunk addresses on the set of member drives, and a reconstruction algorithm indicator; based on the identifications of the set of member drives, sending at least one data request to each of the set of member drives, the at least one data request including a respective member chunk address of the respective member drive; in response to the at least one data request sent to each member drive, receiving a respective data chunk extracted from the respective member drive based on the respective member chunk address; and using the designated reconstruction algorithm; and generating the target data chunk based on respective data chunks extracted from the set of member drives, and the specified reconstruction algorithm.

In another aspect, some implementations include a memory system or a memory device (e.g., SSDs) that includes a plurality of memory drives (e.g., solid-state drives (SSDs)). Each memory drive includes one or more processors and memory having instructions stored thereon for performing any of the above methods of reconstructing data.

In yet another aspect, some implementations include a non-transitory computer readable storage medium storing one or more programs. The one or more programs include instructions, which when executed by a memory system (e.g., SSDs) cause the memory system to implement any of the above methods to reconstruct data.

These illustrative embodiments and implementations are mentioned not to limit or define the disclosure, but to provide examples to aid understanding thereof. Additional embodiments are discussed in the Detailed Description, and further description is provided there.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is a block diagram of an example system module in a typical electronic system in accordance with some embodiments.

FIG. 2 is a block diagram of a memory system of an example electronic device, in accordance with some embodiments.

FIG. 3 is a block diagram of an example electronic system that includes a memory system having an internal processing capability, in accordance with some embodiments.

FIGS. 4A and 4B are block diagrams of an example memory system that reconstructs a target data chunk of a first drive on a target drive, in accordance with some embodiments.

FIG. 5 is a block diagram of an example electronic system including a host device and a memory system, in accordance with some embodiments.

FIG. 6 is a diagram of a structured data command issued by a host device, in accordance with some embodiments.

FIGS. 7A and 7B are block diagrams of an example memory system that reconstructs two data chunks of a first drive, in accordance with some embodiments.

FIGS. 8A and 8B are block diagrams of an example memory system that generates integrity data (e.g., a parity data chunk), in accordance with some embodiments.

FIG. 9 is a flow diagram of an example method for reconstructing data at a memory system, in accordance with some embodiments.

FIG. 10 is a flow diagram of an example method for reconstructing data at a memory system, in accordance with some embodiments.

Like reference numerals refer to corresponding parts throughout the several views of the drawings.

### DETAILED DESCRIPTION

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with storage capabilities.

Various embodiments of this application are directed to methods, memory systems, and memory devices for reconstructing data lost on one of a plurality of memory drives of a memory system locally on the memory system. A target data chunk is lost on a first memory drive, and reconstructed on a target drive based on a set of data chunks of a set of member drives associated with the first memory drive. The set of data chunks are communicated between the set of member drives and the target drive without requiring a host device as an intermediary. Stated another way, the host device may offload reconstruction of the target data chunk lost on the first memory device to the memory system itself. In an example, the target data chunk includes Reed-Solomon error-correcting codes determined based on the set of data chunks of the set of member drives. By these means, reconstruction of the target data chunk (which could be part of user data or associated parity data), if implemented locally on the memory system, may be simplified compared with reconstruction managed by the host device.

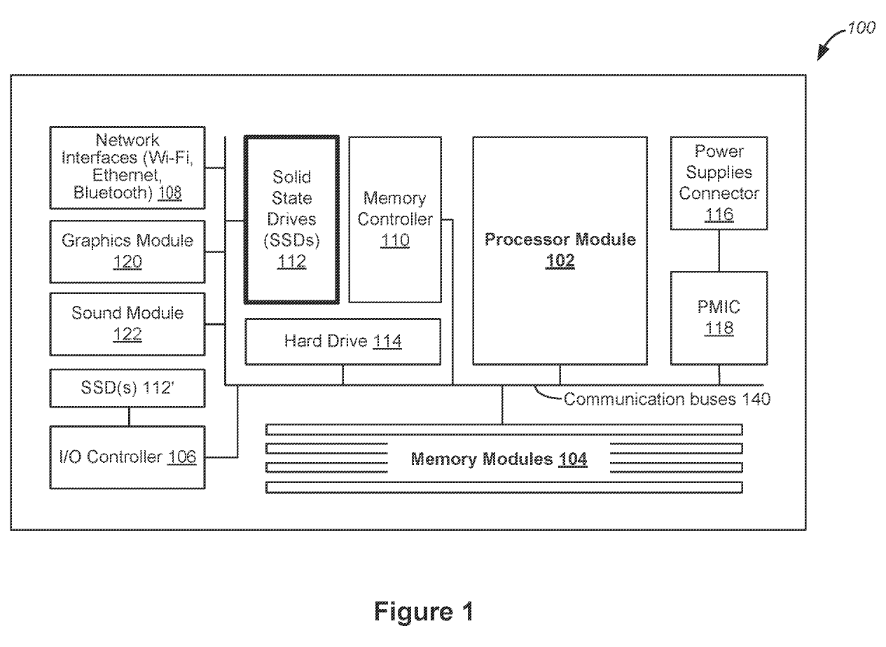

FIG. 1 is a block diagram of an example system module 100 in a typical electronic system in accordance with some embodiments. The system module 100 in this electronic system includes at least a processor module 102, memory modules 104 for storing programs, instructions and data, an input/output (I/O) controller 106, one or more communication interfaces such as network interfaces 108, and one or more communication buses 140 for interconnecting these components. In some embodiments, the I/O controller 106 allows the processor module 102 to communicate with an I/O device (e.g., a keyboard, a mouse or a trackpad) via a universal serial bus interface. In some embodiments, the network interfaces 108 includes one or more interfaces for Wi-Fi, Ethernet and Bluetooth networks, each allowing the electronic system to exchange data with an external source, e.g., a server or another electronic system. In some embodiments, the communication buses 140 include circuitry (sometimes called a chipset) that interconnects and controls communications among various system components included in system module 100.

In some embodiments, the memory modules 104 include high-speed random-access memory, such as static random-access memory (SRAM), double data rate (DDR) dynamic random-access memory (DRAM), or other random-access solid state memory devices. In some embodiments, the memory modules 104 include non-volatile memory, such as one or more magnetic disk storage devices, optical disk storage devices, flash storage devices, or other non-volatile solid state storage devices. In some embodiments, the memory modules 104, or alternatively the non-volatile storage device(s) within the memory modules 104, include a non-transitory computer readable storage medium. In some embodiments, memory slots are reserved on the system module 100 for receiving the memory modules 104. Once inserted into the memory slots, the memory modules 104 are integrated into the system module 100.

In some embodiments, the system module 100 further includes one or more components selected from a memory controller 110, SSD(s) 112, an HDD 114, power management integrated circuit (PMIC) 118, a graphics module 120, and a sound module 122. The memory controller 110 is configured to control communication between the processor module 102 and memory components, including the memory modules 104, in the electronic system. The SSD(s) 112 are configured to apply integrated circuit assemblies to store data in the electronic system, and in many embodiments, are based on NAND or NOR memory configurations. The HDD 114 is a conventional data memory device used for storing and retrieving digital information based on electromechanical magnetic disks. The power supply connector 116 is electrically coupled to receive an external power supply. The PMIC 118 is configured to modulate the received external power supply to other desired DC voltage levels, e.g., 5V, 3.3V or 1.8V, as required by various components or circuits (e.g., the processor module 102) within the electronic system. The graphics module 120 is configured to generate a feed of output images to one or more display devices according to their desirable image/video formats. The sound module 122 is configured to facilitate the input and output of audio signals to and from the electronic system under control of computer programs.

Alternatively or additionally, in some embodiments, the system module 100 further includes SSD(s) 112’ coupled to the I/O controller 106 directly. Conversely, the SSDs 112 are coupled to the communication buses 140. In an example, the communication buses 140 operates in compliance with Peripheral Component Interconnect Express (PCIe or PCI-E), which is a serial expansion bus standard for interconnecting the processor module 102 to, and controlling, one or more peripheral devices and various system components including components 110-122.

Further, one skilled in the art knows that other non-transitory computer readable storage media can be used, as new data storage technologies are developed for storing information in the non-transitory computer readable storage media in the memory modules 104, SSD(s) 112 or 112’, and HDD 114. These new non-transitory computer readable storage media include, but are not limited to, those manufactured from biological materials, nanowires, carbon nanotubes and individual molecules, even though the respective data storage technologies are currently under development and yet to be commercialized.

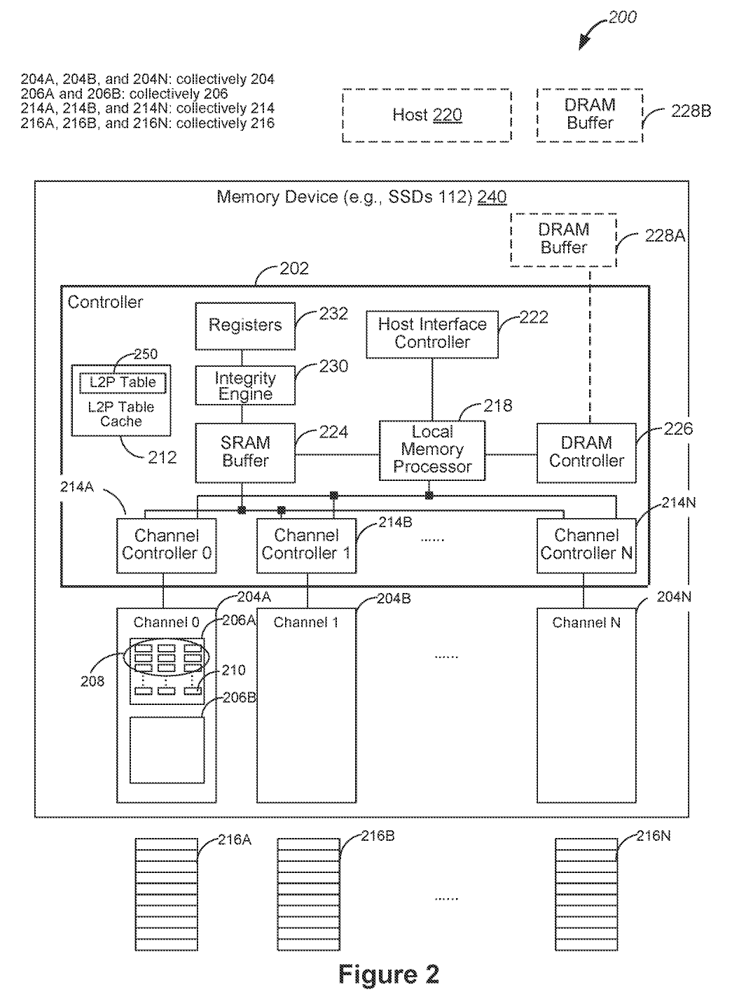

FIG. 2 is a block diagram of a memory system 200 of an example electronic device, in accordance with some embodiments. The memory system 200 is coupled to a host device 220 (e.g., a processor module 102 in FIG. 1) and configured to store instructions and data for an extended time, e.g., when the electronic device sleeps, hibernates, or is shut down. The host device 220 is configured to access the instructions and data stored in the memory system 200 and process the instructions and data to run an operating system (OS) and execute applications. The memory system 200 includes one or more memory devices 240 (e.g., SSD(s)). Each memory device 240 further includes a controller 202 and a plurality of memory channels 204 (e.g., channel 204A, 204B, and 204N). Each memory channel 204 includes a plurality of memory cells. The controller 202 is configured to execute firmware level software to bridge the plurality of memory channels 204 to the host device 220. In some embodiments, each memory device 240 is formed on a printed circuit board (PCB).

Each memory channel 204 includes one or more memory packages 206 (e.g., two memory dies). In an example, each memory package 206 (e.g., memory package 206A or 206B) corresponds to a memory die. Each memory package 206 includes a plurality of memory planes 208, and each memory plane 208 further includes a plurality of memory pages 210. Each memory page 210 includes an ordered set of memory cells, and each memory cell is identified by a respective physical address. In some embodiments, the memory device 240 includes a plurality of superblocks. Each superblock includes a plurality of memory blocks each of which further includes a plurality of memory pages 210. For each superblock, the plurality of memory blocks are configured to be written into and read from the memory system via a memory input/output (I/O) interface concurrently. Optionally, each superblock groups memory cells that are distributed on a plurality of memory planes 208, a plurality of memory channels 204, and a plurality of memory dies 206. In an example, each superblock includes at least one set of memory pages, where each page is distributed on a distinct one of the plurality of memory dies 206, has the same die, plane, block, and page designations, and is accessed via a distinct channel of the distinct memory die 206. In another example, each superblock includes at least one set of memory blocks, where each memory block is distributed on a distinct one of the plurality of memory dies 206 includes a plurality of pages, has the same die, plane, and block designations, and is accessed via a distinct channel of the distinct memory die 206. The memory device 240 stores information of an ordered list of superblocks in a cache of the memory device 240. In some embodiments, the cache is managed by a host driver of the host device 220, and called a host managed cache (HMC).

In some embodiments, the memory device 240 includes a single-level cell (SLC) NAND flash memory chip, and each memory cell stores a single data bit. In some embodiments, the memory device 240 includes a multi-level cell (MLC) NAND flash memory chip, and each memory cell of the MLC NAND flash memory chip stores 2 data bits. In an example, each memory cell of a triple-level cell (TLC) NAND flash memory chip stores 3 data bits. In another example, each memory cell of a quad-level cell (QLC) NAND flash memory chip stores 4 data bits. In yet another example, each memory cell of a penta-level cell (PLC) NAND flash memory chip stores 5 data bits. In some embodiments, each memory cell can store any suitable number of data bits (e.g., X data bits, where X is greater than 5). Compared with the non-SLC NAND flash memory chips (e.g., MLC SSD, TLC SSD, QLC SSD, PLC SSD), the SSD that has SLC NAND flash memory chips operates with a higher speed, a higher reliability, and a longer lifespan, and however, has a lower device density and a higher price.

Each memory channel 204 is coupled to a respective channel controller 214 (e.g., controller 214A, 214B, or 214N) configured to control internal and external requests to access memory cells in the respective memory channel 204. In some embodiments, each memory package 206 (e.g., each memory die) corresponds to a respective queue 216 (e.g., queue 216A, 216B, or 216N) of memory access requests. In some embodiments, each memory channel 204 corresponds to a respective queue 216 of memory access requests. Further, in some embodiments, each memory channel 204 corresponds to a distinct and different queue 216 of memory access requests. In some embodiments, a subset (less than all) of the plurality of memory channels 204 corresponds to a distinct queue 216 of memory access requests. In some embodiments, all of the plurality of memory channels 204 of the memory device 240 corresponds to a single queue 216 of memory access requests. Each memory access request is optionally received internally from the memory device 240 to manage the respective memory channel 204 or externally from the host device 220 to write or read data stored in the respective channel 204. Specifically, each memory access request includes one of: a system write request that is received from the memory device 240 to write to the respective memory channel 204, a system read request that is received from the memory device 240 to read from the respective memory channel 204, a host write request that originates from the host device 220 to write to the respective memory channel 204, and a host read request that is received from the host device 220 to read from the respective memory channel 204. It is noted that system read requests (also called background read requests or non-host read requests) and system write requests are dispatched by a memory controller 202 to implement internal memory management functions including, but are not limited to, garbage collection, wear levelling, read disturb mitigation, memory snapshot capturing, memory mirroring, caching, and memory sparing. In some embodiments, each of a host write request and a host read request corresponds to a respective input/output (I/O) access operation. Alternatively, in some embodiments, each of a system read request, a system write request, a host write request, and a host read request corresponds to a respective input/output (I/O) access operation

In some embodiments, in addition to the channel controllers 214, the controller 202 further includes a local memory processor 218, a host interface controller 222, an SRAM buffer 224, and a DRAM controller 226. The local memory processor 218 accesses the plurality of memory channels 204 based on the one or more queues 216 of memory access requests. In some embodiments, the local memory processor 218 writes into and read from the plurality of memory channels 204 on a memory block basis. Data of one or more memory blocks are written into, or read from, the plurality of channels jointly. No data in the same memory block is written concurrently via more than one operation. Each memory block optionally corresponds to one or more memory pages. In an example, each memory block to be written or read jointly in the plurality of memory channels 204 has a size of 16 KB (e.g., one memory page). In another example, each memory block to be written or read jointly in the plurality of memory channels 204 has a size of 64 KB (e.g., four memory pages). In some embodiments, each memory block has a size corresponding to a plurality of pages distinct from 16 KB and 64 KB. In some embodiments, each page has 16 KB user data and 2 KB metadata. Additionally, a number of memory blocks to be accessed jointly and a size of each memory block are configurable for each of the system read, host read, system write, and host write operations.

In some embodiments, the local memory processor 218 stores data to be written into, or read from, each memory block in the plurality of memory channels 204 in an SRAM buffer 224 of the controller 202. Alternatively, in some embodiments, the local memory processor 218 stores data to be written into, or read from, each memory block in the plurality of memory channels 204 in a DRAM buffer 228A that is included in memory device 240, e.g., by way of the DRAM controller 226. Alternatively, in some embodiments, the local memory processor 218 stores data to be written into, or read from, each memory block in the plurality of memory channels 204 in a DRAM buffer 228B that is main memory used by the processor module 102 (FIG. 1). The local memory processor 218 of the controller 202 accesses the DRAM buffer 228B via the host interface controller 222.

In some embodiments, data in the plurality of memory channels 204 is grouped into coding blocks, and each coding block is called a codeword. For example, each codeword includes n bits among which k bits correspond to user data and (n – k) corresponds to integrity data of the user data, where k and n are positive integers. In some embodiments, the memory device 240 includes an integrity engine 230 (e.g., an LDPC engine) and registers 232, which include a plurality of registers or SRAM cells or flip-flops and are coupled to the integrity engine 230. The integrity engine 230 is coupled to the memory channels 204 via the channel controllers 214 and SRAM buffer 224. Specifically, in some embodiments, the integrity engine 230 has data path connections to the SRAM buffer 224, which is further connected to the channel controllers 214 via data paths that are controlled by the local memory processor 218. The integrity engine 230 is configured to verify data integrity and correct bit errors for each coding block of the memory channels 204.

In some embodiments, the memory system 200 includes an SSD having an L2P address indirection table 250 that stores physical addresses for a set of logical addresses, e.g., a logical block address (LBA). In some embodiments, the L2P address indirection table 250 is stored in an L2P table cache 212 included in the controller 202. Alternatively, in some embodiments, the memory system 200 includes a DRAM buffer 228A, and the L2P address indirection table 250 is stored in the DRAM buffer 228A. The local memory processor 218 of the controller 202 accesses the DRAM buffer 228A via a DRAM controller 226.

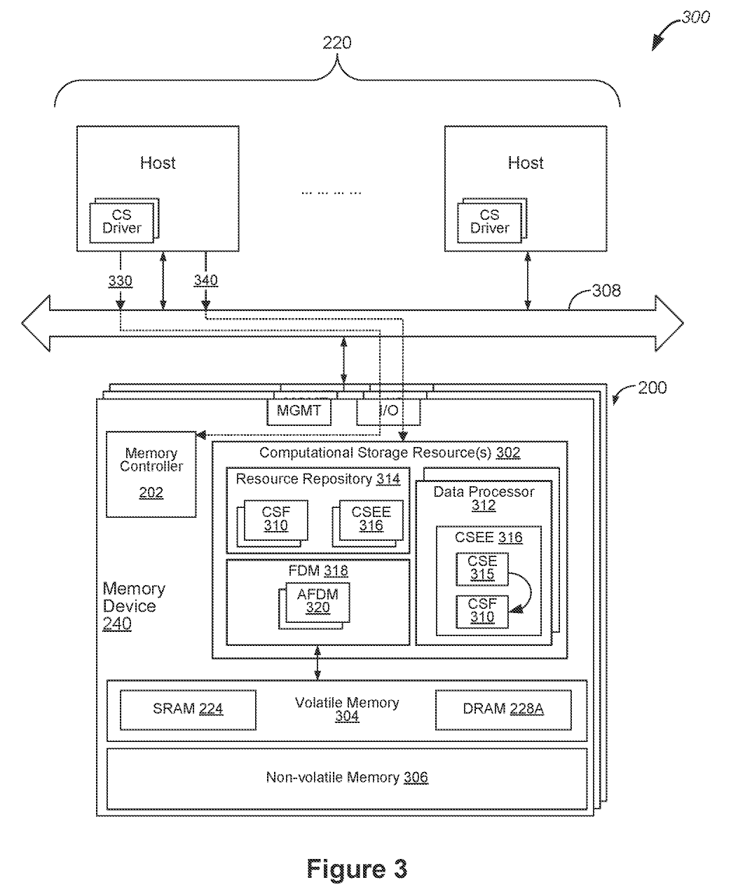

In some embodiments, a memory device 240 (also called a storage device) includes a plurality of processing cores, and is transformed to a CSD by activating a computational storage configuring two separate subsets of processing cores to a memory controller 202 and a data processor (e.g., data processor 312 in FIG. 3), respectively. The data processor is configured to process internal computational storage operations (e.g., data processing operations) locally on the memory device 240, while the memory controller 202 of the memory device 240 specializes in performing generic storage functions including memory access functions (e.g., input/output (I/O) access operations) and internal memory management functions. In some embodiments, the memory controller 202 and the data processor of the memory device 240 at least partially share certain hardware resources in a time-multiplexed manner. The memory device 240 may operate in a computational storage elevation (CSE) mode, when the hardware resources (e.g., processing cores) are allocated to the computational storage functions or adjusted between the memory access functions and the computational storage functions.

FIG. 3 is a block diagram of an example electronic system 300 that includes a memory system 200 having an internal processing capability, in accordance with some embodiments. The memory system 200 is also called a CSD, and includes one or more memory devices 240 (e.g., SSDs). Each memory device 240 further includes a memory controller 202, a volatile memory 304, and a non-volatile memory 306 (e.g., memory channels 204). The host device(s) 220 and the one or more memory devices 240 of the memory system 200 are coupled to each other via a communication fabric 308. The communication fabric 308 includes a communication bus 140 (FIG. 1) that operates in compliance with a data bus standard, e.g., Peripheral Component Interconnect Express (PCIe), Ethernet standards. The host device(s) 220 are configured to issue memory access requests to write data into, and read data from, the non-volatile memory 306. The memory controller 202 accesses the non-volatile memory 306 in response to the memory access operations. Additionally, in some embodiments, the memory controller 202 dispatch system read requests (also called background read requests or non-host read requests) and system write requests to implement internal memory management functions including, but are not limited to, garbage collection, wear levelling, read disturb mitigation, memory snapshot capturing, memory mirroring, caching, and memory sparing. The volatile memory 304 of each memory device 240 further includes one or more of a L2P table cache 212, an SRAM buffer 224, and a DRAM buffer 228A, and is configured to store data temporarily while the memory controller 202 accesses the non-volatile memory 306 for memory accesses or internal memory management.

In some embodiments, the memory controller 202 is dedicated to processing the memory access requests and internal memory management functions. A memory device 240 further includes one or more computational storage resources (CSRs) 302 configured to implement data processing operations locally on the memory device 240. A set of predefined data processing operations are implemented to perform a computational storage function (CSF) 310, which is distinct from the memory access and internal memory management functions performed by the memory controller 202. In some embodiments, a computational storage resource 302 processes user data that are received from the host device(s) 220 or extracted from the non-volatile memory 306 during the data processing operations. In some embodiments, the processed data are stored into the non-volatile memory 306 or sent to the host device(s) 220 via the fabric 308. Further, in some embodiments, a subset of the user data, the process data, and intermediate data generated during the data processing operations is temporarily stored in the volatile memory 304 (e.g., SRAM buffer 224, DRAM buffer 228A).

In some embodiments, the computational storage resource 302 includes one or more data processors 312 and a resource repository 314. The one or more data processors 312 provide a computational storage engine configured to perform one or more predefined data processing operations, e.g., associated with a computational storage function 310 of the computational storage resource 302. In some embodiments, the computational storage function 310 corresponds to an in-memory application associated with the computational storage engine, and is implemented via the computational storage engine in the memory device 240. The resource repository 314 is a centralized location (e.g., memory space) storing various types of data and resources, such as software libraries, configuration files, media files, or any other type of data needed for a plurality of computational storage functions 310 performed by the computational storage resource 302. For example, the resource repository 314 stores instructions for creating a computational storage engine environment (CSEE) 316 and instructions for implementing a set of data processing operations associated with a computational storage function 310 in the CSEE 316. Instructions are loaded from the resource repository 314 and executed by the data processor 312, thereby creating the CSEE 316 where the computational storage engine 315 is executed to implement data processing operations associated with the computational storage function 310.

In some embodiments, the computational storage resource 302 further includes a function data memory (FDM) 318 for storing data that are used or generated by the computational storage engine 315 for performing a computational storage function 310. In some embodiments, the function data memory 318 is included in the volatile memory 304. For example, the function data memory 318 corresponds to a portion of the DRAM buffer 228A (FIG. 2). In another example, the function data memory 318 corresponds to a portion of the SRAM buffer 224 (FIG. 2). Further, in some embodiments, a portion of the function data memory 318 (also called an allocated FDM (AFDM) 320) is allocated for one or more instances of a computational storage function 310.

In some embodiments, a host device 22 issues a memory read or write request 330 to a memory device 240 of the memory system 200, and the memory controller 202 of the memory device 240 receives the memory read or write request 330 and accesses the non-volatile memory 306 accordingly. Alternatively, in some embodiments, a host device 22 issues a data processing request 340 to the memory device 240, and a data processor 312 of the computational storage resource 302 (e.g., the computational storage engine 315) receives the data processing request 340 and processes user data extracted from the data processing request or the non-volatile memory 306.

In some embodiments, the memory system 200 operates in compliance with a storage access and transport protocol (e.g., nonvolatile memory express (NVMe)), in accordance with some embodiments. The memory system 200 includes one or more memory devices 240 each of which corresponds to a domain according to the storage access and transport protocol. Each domain corresponds to a respective memory device 240 includes a one or more compute namespace, local memory namespaces, memory namespaces, and a domain controller. Each namespace is a collection of LBAs accessible to, or associated with, a respective one of the plurality of programs. In some embodiments, the host device 220 uses an operating system (e.g., a Linux operating system), and the CSRs 302 (FIG. 3) of the memory device 240 uses an embedded operating system (e.g., an embedded Linux operating system) that matches the operating system of the host device 220. In some embodiments, the host device 220 uses extended vendor unique commands to control and interact with the embedded operating system of the CSRs 302 of the memory device 240.

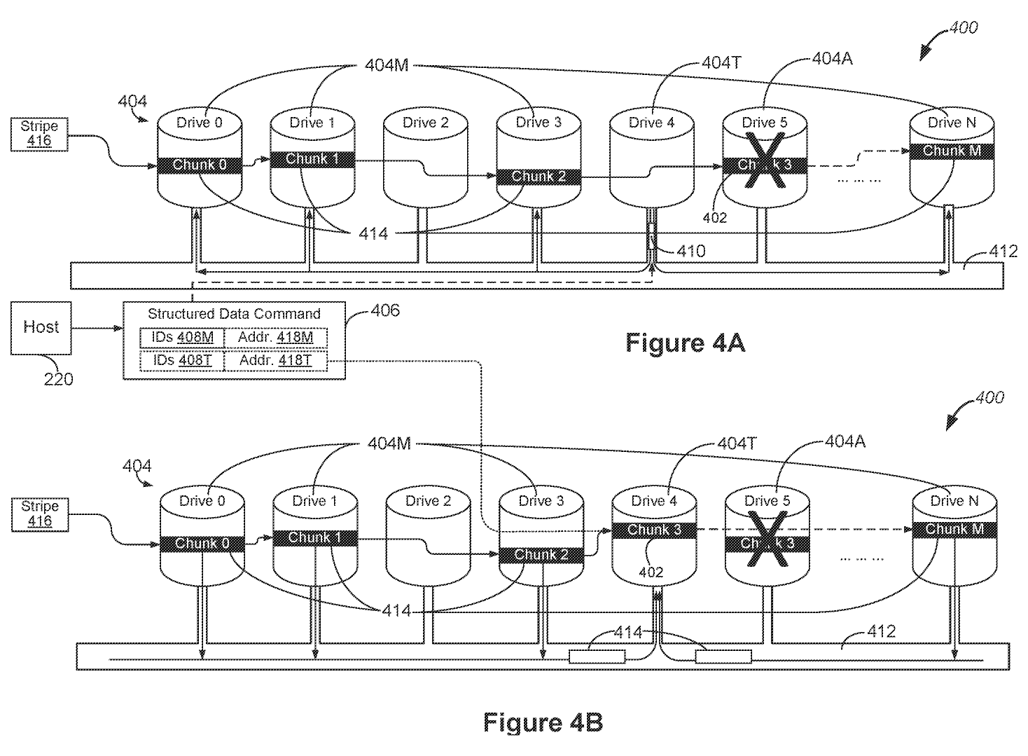

FIGS. 4A and 4B are block diagrams of an example memory system 400 that reconstructs a target data chunk 402 of a first drive 404A on a target drive 404T, in accordance with some embodiments. The memory system 400 includes a plurality of memory drives 404 (e.g., Drives 0-N, where N is a positive integer equal to or greater than (≥) 2), and the plurality of memory drives 404 further include a set of member drives 404M (e.g., Drives 0, 1, 3, and N) and a target drive 404T (e.g., Drive 5) distinct from each of the set of member drives 404M. In some embodiments, each memory drive 404 (e.g., member drives 404M, target drive 404T) includes a respective SSD, and the respective SSD includes a plurality of NAND flash memory cells organized in a plurality of memory channels (e.g., channels 204 in FIG. 2). In some embodiments, each of the plurality of memory drives 404 has an interface selected from Small Computer System Interface (SCSI), a Serial Storage Architecture (SSA) interface, a Fibre Channel interface, an Internet SCSI (iSCSI) interface, and a Serial-Attached SCSI (SAS) interface. More details on the memory system 400 are described above with reference to the memory system 200 in FIG. 2.

Referring to FIG. 4A, the memory system 400 obtains a structured data command 406 including identifications 408M of the set of member drives 404M, and extracts the identifications 408M of the set of member drives 404M from the structured data command 406. Based on the identifications 408M of the set of member drives 404M, the memory system 400 (specifically, the target drive 404T) generates at least one data request 410 and sends the at least one data request 410 to each of the set of member drives 404M, e.g., via a peer-to-peer communication channel 412. In some embodiments, the at least one data request 410 includes a single data request for the target data chunk 402. Alternatively, in some embodiments, the at least one data request 410 includes two or more data requests each corresponding to a subset of the target data chunk 402.

Referring to FIG. 4B, in some embodiments, in response to the at least one data request 410 sent to each member drive 404M , the memory system 400 (specifically, the target drive 404T) obtains a respective data chunk 414 extracted from the respective member drive 404M, generates the target data chunk 402 based on respective data chunks 414 extracted from the set of member drives 404M, and stores the target data chunk 402 on the target drive 404T. The structured data command 406 may be obtained and processed by the target drive 404T to generate the data requests 410 and the target data chunk 402. In some embodiments, the respective data chunks 414 of the set of member drive 404M and the target data chunk 402 of the target drive 404T form a data stripe 416 that is stored in the memory system 400 in a distributed manner. Further, in some embodiments, the data stripe 416 further includes one or more supplemental chunks (not shown) distinct from the data chunks 414 and 402, and the one or more supplemental chunks are not used to reconstruct the target data chunk 402. Each of the data chunks 402 and 414 has a chunk size smaller than a chunk size limit (e.g., defined according to a capability of each write operation). In an example, the data stripe 416 includes M data chunks (e.g., Chunk 0 stored on Drive 0, Chunk 1 stored on Drive 1, Chunk 2 stored on Drive 3, Chunk 3 stored on Drive 5, …, and Chunk M stored on Drive N), where M is a positive integer and equal to or smaller than (≤) N. The target drive 404T is Drive 4, and the target data chunk 402 includes Chunk 3 stored on Drive 5 and is reconstructed from Chunks 0, 1, 2, …, and N. Stated another way, the data stripe 416 may include all memory drives or less than all memory drives of the memory system 400.

In some embodiments, the structured data command 406 further includes an identification 408T of the target drive 404T and a target chunk address 418T on the target drive 404T. The memory system 400 identifies the target drive 404T based on the identification of the target drive 404T. The target data chunk 402 is stored on the target drive 404T based on the target chunk address 418T. In some embodiments, the structured data command 406 further includes a set of member chunk addresses 418M on the set of member drives 404M. For each of the set of member drives 404M, the at least one data request 410 includes a respective member chunk address 418M of the respective member drive 404M, and the respective data chunk 414 is extracted from the respective member drive 404M based at the respective member chunk address 418M.

In some embodiments, the respective data chunk 414 of one of the set of member drives 404M is selected from Reed-Solomon error-correction codes, Hamming error codes, Low-density parity-check (LDPC) codes, and XOR-based error-correction codes, and the target data chunk 402 includes a subset of user data applied to generate the respective data chunk 414 of the one of the set of member drives 404M. Stated another way, the target data chunk 402 incudes part of the user data used to generate associated integrity data, and the respective data chunk 414 of the one of the set of member drives 404M (e.g., Chunk 0 on Drive 0, Chunk M on Drive N) includes part or all of the associated integrity data. The part of the user data included in the target data chunk 402 is recovered locally by the target drive 404T from the associated integrated data included in the respective data chunk 414 of the one of the set of member drives 404M.

In some embodiments, the plurality of memory drives 404 are communicatively coupled to one another via a Peripheral Component Interconnect Express (PCIe) bus, and the target drive 404T receives the respective data chunk 414 extracted from each respective member drive 404M via the PCIe bus without involving a host device 220. Stated another way, the PCIe bus may be used as a peer-to-peer communication channel 412. In some implementations, the PCIe bus is applied for both host-memory communication and peer-to-peer communication.

In some embodiments, a memory system 400 stores data according to a redundant array of independent disks (RAID) scheme in which a data stripe 416 is built across a group of memory drives 404 (e.g., including memory drives 404M and 404A). Each memory drive of the group of memory drives stores a respective data chunk (e.g., chunk 414 or 402) of the data stripe 416. In an example, the memory system 400 applies Reed-Solomon error-correction codes in the data stripe 416. In some embodiments, the memory system 400 uses erasure coding to scatter data chunks 414 and 402 across memory drives 404M and 404A. A subset of data chunks holds user data, while another subset of data chunks holds error-correction codes (also called parity data, XOR data, or integrity data). A combination of user data and parity data is used to rebuild or reconstruct data 402 that is lost due to media defects or drive failures. The memory system 400 builds at least one parity data chunk when it creates a stripe 416, e.g., by performing Reed-Solomon calculations based on data chunks stored on other memory drives corresponding to the same data stripe 416.

In some embodiments, respective data chunks 414 of the set of member drives 404M and the target data chunk 402 of the target drive 404T are arranged according to a redundant array of independent disks (RAID) scheme selected from RAID1, RAID3, RAID5, RAID6, RAID-N, RAID10, RAID50, and RAID60. For example, RAID1 is a mirroring configuration where data is duplicated on two or more memory drives 404 for redundancy. If one memory drive fails, the data is still available on the other memory drive. RAID3 uses byte-level striping, where data is split into smaller chunks (bytes) and written across two or more memory drives 404. One drive is dedicated to storing parity information (also called integrity data), which provides redundancy in case one drive fails. In RAID5, data is split into blocks and distributed across two or more memory drives 404, with one drive holding the parity information. Parity is used to recover data if one drive fails. RAID6 is similar to RAID5 but adds an extra chunk of parity. RAID-N is implemented using custom RAID setups where the exact RAID type can vary depending on the number of drives and the desired balance of performance, redundancy, and capacity, where “N” represents the number of memory drives 404 used (e.g., for storing parity data, for storing both user data and parity data). RAID10 combines the features of RAID1 and RAID0, and mirrors data (RAID1) across two or more memory drives 404 for redundancy, while also striping data (RAID0) across pairs of memory drives 404. RAID10 may require a minimum of four memory drives 404. RAID50 combines RAID5’s block-level striping and distributed parity with RAID0’s striping. RAID60 combines RAID6’s double parity (which allows for the failure of two memory drives 404) with RAID0’s striping.

In some embodiments, the memory system 400 (also called a storage system) includes a plurality of processing cores, and is transformed to a CSD by configuring two subsets of processing cores to a memory controller 202 and a data processor 312 (FIG. 3), respectively. The data processor 312 is configured to process internal computational storage operations (e.g., data processing operations) locally on the memory system 400 (e.g. each memory drive 404), while the memory controller 202 of the memory system 400 (e.g. each memory drive 404) specializes in performing generic storage functions including memory access functions (e.g., input/output (I/O) access operations) and internal memory management functions. For example, the target drive 404T may apply its data processor 312 to generate the target data chunk 402 based on respective data chunks 414 extracted from the set of member drives 404M, and its memory controller 202 to store the target data chunk 402 on the target drive 404T.

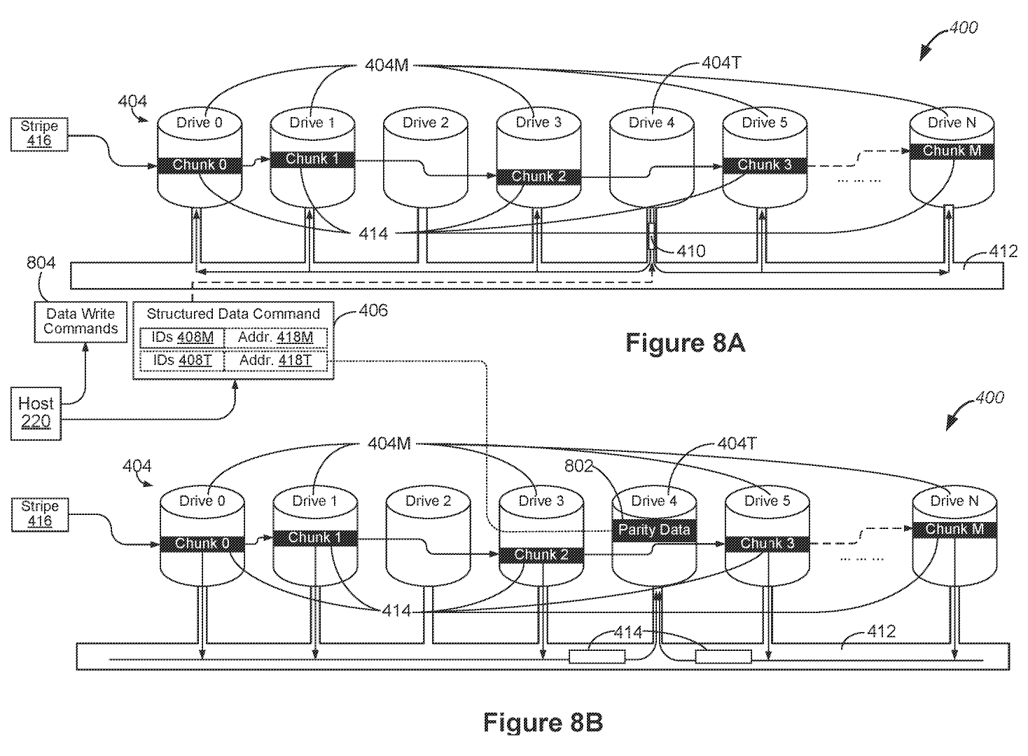

In some situations, when the target data chunk 402 is reconstructed by the target drive 404T, the host device 220 identifies the target data chunk 402, the set of member drives 404M having the set of data chunks 414 in the same data stripe 416 as the target data chunk 402, and the target drive 404T where the target data chunk 402 is reconstructed. The host device 220 generates a structured data command 406 and sends the structured data command 406 to the target drive 404T, which reconstructs the target data chunk 402 and store the reconstructed target data chunk 402. Each target drive 404T receives and processes the structured data command 406, reads the set of data chunks 414 from the set of member drives 404M corresponding to the data stripe 416, determines the target data chunk 402 based on the set of data chunks 414, and stores the target data chunk 402 at a memory location (e.g., defined by the host device 220 in the structured data command 406). When reconstruction of the target data chunk 402 is completed, the target drive 404T sends a completion status to the host device 220. Alternatively, in some embodiments, the memory system 400 builds a parity data chunk locally during the course of writing a data stripe 416. More details on local parity data construction are explained below with reference to FIGS. 8A and 8B.

In some embodiments, the structured data command 406 is obtained and processed by the target drive 404T to generate the data requests 410 and the target data chunk 402. In some embodiments, the structured data command 406 is obtained and processed by the memory system 400 on a system level to generate the data requests 410 and the target data chunk 402. In some embodiments, the structured data command 406 is obtained and processed by a combination of system-level firmware and drive-level firmware to generate the data requests 410 and the target data chunk 402.

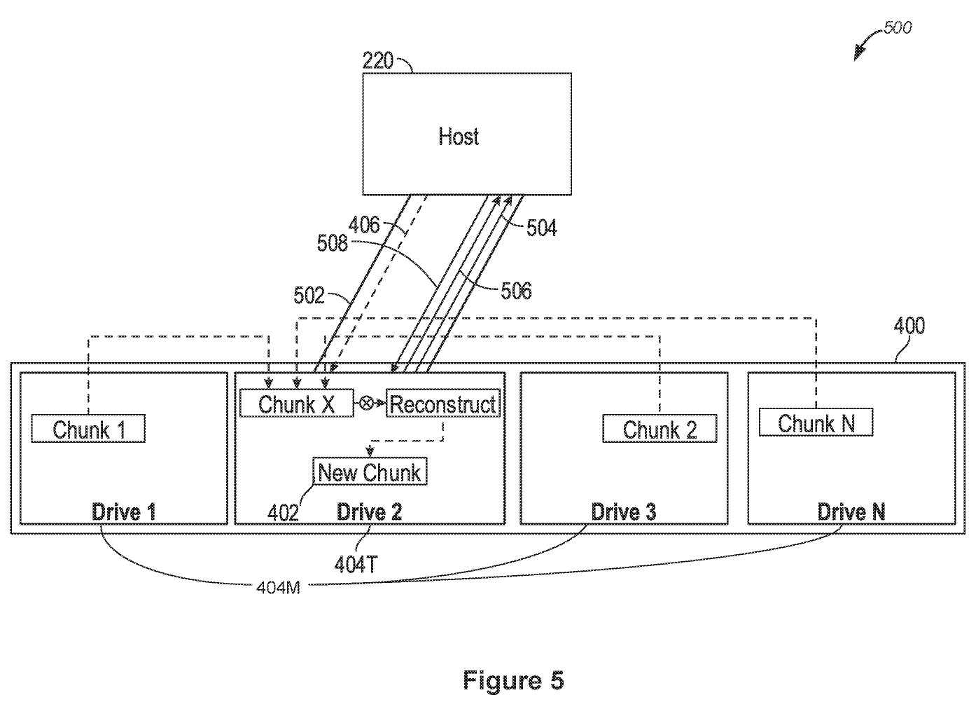

FIG. 5 is a block diagram of an example electronic system 500 including a host device 220 and a memory system 400, in accordance with some embodiments. The memory system 400 is coupled to the host device 220 and configured to communicate with the host device 220 via a PCIe bus 502, and the structured data command 406 is received from the host device 220 via the PCIe bus 502 in compliance with a Non-Volatile Memory Express (NVMe) or NVMe over fabrics (NVMeOF) protocol. A target drive 404T of the memory system 400 receives the structured data command 406, and reconstructs a target data chunk 402.

In response to the structured data command 406, the target drive 404T reads a first data chunk (Chunk 1) from a first member drive (Drive 1) based on logical block addressing (LBA). The structured data command 406 includes a logical address of the first data chunk (Chunk 1), and the LBA is applied to determine a physical address of the first member drive (Drive 1). The first data chunk (Chunk 1) is extracted from the physical address of the first member drive (Drive 1) and provided to the target drive 404T via the peer-to-peer communication channel 412, allowing the target drive 404T to initialize reconstruction of the target data chunk 402. In some embodiments, the target data chunk 402 is reconstructed based on two or more data chunks 414 stored on the member drives 404M, and the target drive 404T iteratively reads data chunks 414 (e.g., Chunk 2 and Chunk N) from one or more remaining member drives 404M (e.g., Drive 2 and Drive N) distinct from the first member drive (Drive 1). In some embodiments, the target drive 404T dynamically determines and updates the target data chunk 402, while collecting the respective data chunks 414 associated with the target data chunk 402 from the set of member drives 404M. Alternatively, in some embodiments, the target drive 404T reconstructs the target data chunk 402, after collecting all of the respective data chunks 414 associated with the target data chunk 402 from the set of member drives 404M. After the target data chunk 402 is finalized, the target drive 404T stores the target data chunk 402 and updates the LBA to map a logical address of the target data chunk 402 to a physical address of the target drive 404T.

In some embodiments, in response to the structured data command 406, the target drive 404T (e.g., Drive 2 in FIG. 5) successively reconstructs the target data chunk 402, stores the target data chunk 402, and sends a confirmation message 504 to the host device 220 to which the memory system 400 is coupled. The confirmation message 504 indicates a completion status of the target drive 404T. Alternatively, in some embodiments, the target drive 404T determines that an error has occurred during receiving the respective data chunks 414 extracted from the set of member drives 404M or generating the target data chunk 402. The target drive 404T generates an error alert message 506 based on the error, and sends the error alert message 506 to the host device 220 that issues the structured data command 406. The error alert message 506 may not be a separate message. Instead, the error alert message 506 may be included in a confirmation message 504 returned to the host device 220 in response to the structured data command 406 to recover the target data chunk 402. Upon receiving the error alert message 506, the host device 220 may directly fetch the respective data chunks 414 from the set of member drives 404M, generate the target data chunk 402 based on the respective data chunks 414, and send a write request 508 to the target drive 404T to store the target data chunk 402. Stated another way, if the memory system 400 fails to reconstruct the target data chunk 402 locally, the host device 220 intervenes to orchestrate reconstruction of the target data chunk 402 for the target drive 404T. In some situations, before the host device 220 takes over, the target drive 404T may repeatedly send read commands (e.g., data requests 410 in FIG. 4A) to the set of member drives 404M if needed. When the target drive 404T cannot perform the reconstruction, e.g., despite heroic efforts, the target drive 404T may return a confirmation message 406 including an error alert message 506. The host device 220 reconstructs the target data chunk 402 and sends the write request 508 to the target drive 404T, which may write the reconstructed target data chunk 502 successfully and returns another confirmation message 504 to the host device 220. That said, the host device 220 either reissues the structured data command 406 or intervenes to orchestrate reconstruction of the target data chunk 402 by itself.

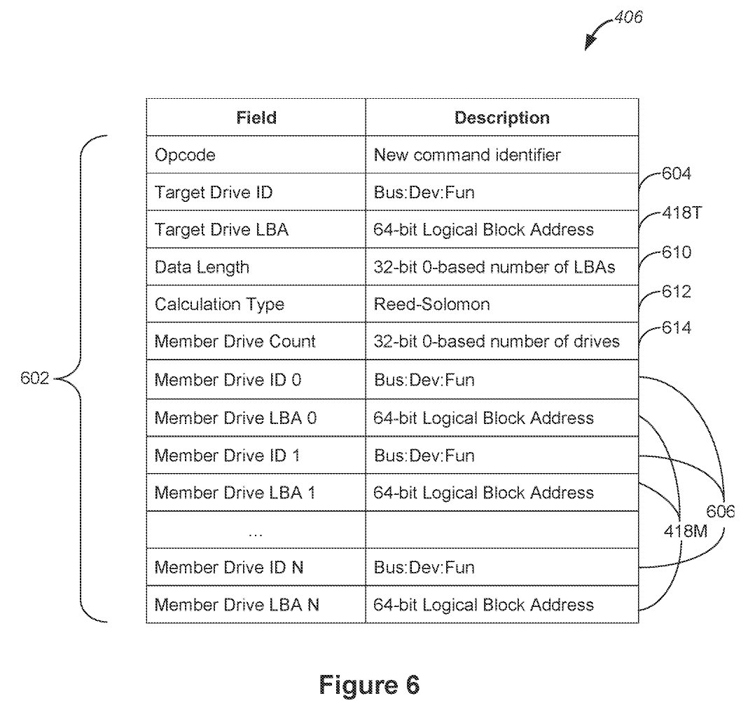

FIG. 6 is a diagram of a structured data command 406 issued by a host device 220, in accordance with some embodiments. The structured data command 406 is received from the host device 220 via the PCIe bus 502 in compliance with an NVMe or NVMe over fabrics (NVMeOF) protocol. A target drive 404T of the memory system 400 receives the structured data command 406, and reconstructs a target data chunk 402, e.g., offloading RAID parity calculation from the host device 220 to the memory system 400. The structured data commands 406 may include an ordered sequence of data fields 602.

In some embodiments, the structured data command 406 includes an identification 604 of the target drive 404T and a target chunk address 418T on the target drive 404T. The target drive 404T is identified based on the identification 604 of the target drive 404T, and the target data chunk 402 is stored on the target drive 404T based on the target chunk address 604. In some embodiments, the structured data command 406 includes target chunk address 418T and a set of member chunk addresses 418M of the set of member drives 404M. For each respective member drive 404M, the set of member chunk addresses 418M includes a respective member chunk address 418M. The at least one data request 410 sent by the target drive to the respective member drive 404M includes the respective member chunk address 418M, allowing the respective data chunk 414 to be extracted from the respective member drive 404M and applied to reconstruct the target data chunk 402 by the target drive 404T

In some embodiments, the structured data command 406 includes one or more of: a data length 610 of the target data chunk 402, a reconstruction algorithm indicator 612 for generating the target data chunk 402, and a number 614 of member drives associated with the target data chunk 402. Further, in some embodiments, based on the reconstruction algorithm indicator 612, a respective reconstruction algorithm is selected to generate the target data chunk 402 as one of Reed-Solomon error-correction codes, Hamming error-correction codes, Low-density parity-check (LDPC) codes, and XOR-based error-correction codes.

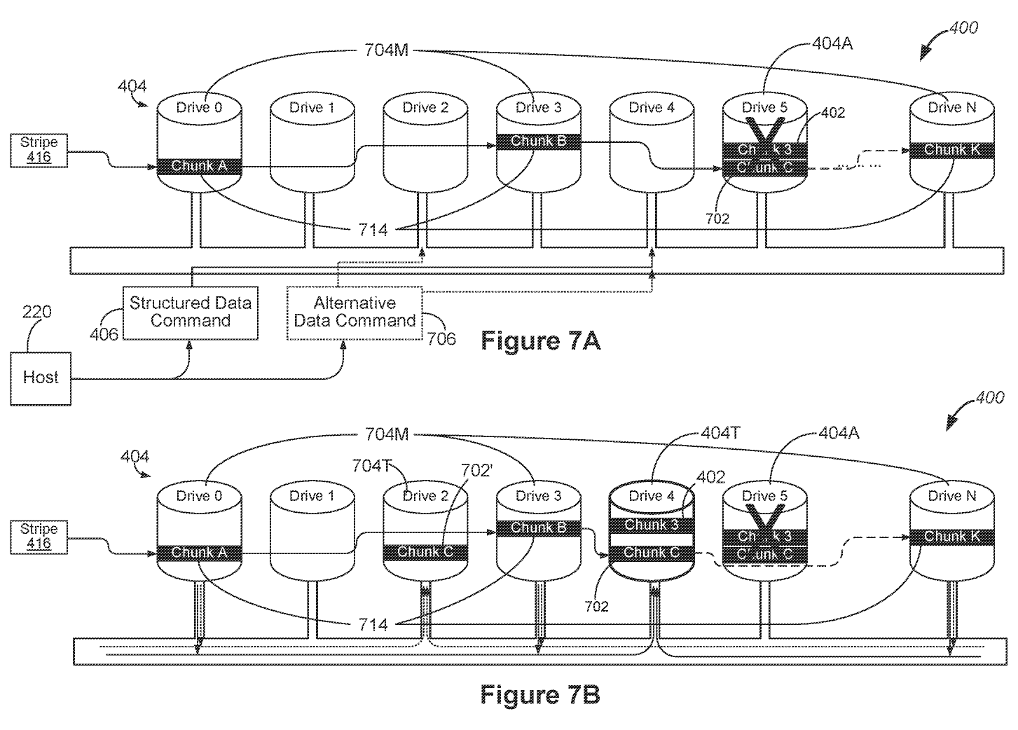

FIGS. 7A and 7B are block diagrams of an example memory system 400 that reconstructs two data chunks of a first drive 404A, in accordance with some embodiments. The memory system 400 is coupled to a host device 220. In some situations, the first drive 404A fails, and the two data chunks need to be reconstructed on one or more memory drives 404 distinct from the first drive 404A. The two data chunks include a target data chunk 402 and an alternative data chunk 702. The target data chunk 402 and the alternative data chunk 702 belong to two distinct data stripes. The host device 220 determines that data stored on the first drive 404A need to be reconstructed, and the data stored on the first drive 404A includes the target data chunk 402 and an alternative data chunk 702. The host device 220 generates the structured data command 406 for reconstructing the target data chunk 402 and an alternative data command 706 for reconstructing the alternative data chunk 702. In some embodiments, the structured data command 406 and the alternative data command 706 comply with the NVMe protocol.

In some embodiments, system intelligence in a NVMe of JBOD (just a bunch of disks) might process the command 406 or 706, rather than sending the commands 406 or 706 to individual memory drives 404. The JBOD may be NVMe or NVMe over fabrics (NVMeoF).

Referring to FIG. 7B, in some embodiments, both the target data chunk 402 (e.g., Chunk 3) and the alternative data chunk 702 (e.g., Chunk C) are reconstructed by the target drive 404T (e.g., Drive 4). Before or after the target data chunk 402 is reconstructed, the target drive 404T obtains the alternative data command 706 including identifications of a set of alternative drives 704M (e.g., Drives 0, 1, and 3). The target drive 404T further generates the alternative data chunk 702 based on respective data chunks 714 (e.g., Chunks A, B, and K) extracted from the set of alternative drives 704M, and stores the alternative data chunk 714 (e.g., Chunk C) on the target drive 404T (e.g., Drive 4). More details on reconstruction of the target data chunk 402 on the target drive 404T are explained above with reference to FIGS. 4A and 4B.

Alternatively, in some embodiments, the target data chunk 402 is reconstructed by the target drive 404T (e.g., Drive 4), and an alternative data chunk 702’ is reconstructed by a second drive 704T (e.g., Drive 2) distinct from the target drive 404T. The second drive 704T obtains the alternative data command 706 including identifications of a set of alternative drives 704M. The second drive 704T (e.g., Drive 2) further generates the alternative data chunk 702’ based on respective data chunks 714 (e.g., Chunks A, B, and K) extracted from the set of alternative drives 704M (e.g., Drives 0, 1, and 3), and stores the alternative data chunk 714 on the second drive 704T. Further, in some embodiments, the alternative data chunk 702’ is generated by the second drive 704T, concurrently while the target data chunk 402 is generated by the target drive 404T. Alternatively, in some embodiments, the alternative data chunk 702’ is generated by the second drive 704T, before or after the target data chunk 402 is generated by the target drive 404T.

In some embodiments, the same structured data command 406 is applied to control reconstruction of both the target data chunk 402 and the alternative data chunk 702. The host device 220 determines that data stored on the first drive 404A need to be reconstructed, and the data stored on the first drive 404A includes the target data chunk 402 and an alternative data chunk 702. The host device 220 generates a single structured data command 406 for reconstructing the target data chunk 402 and the alternative data chunk 702. The structured data command 406 includes identifications of a set of member drives 404M associated with the target data chunk 402 and a set of alternative drives 704M associated with the alternative data chunk 702. In some embodiments, the target drive 404T generates the alternative data chunk 702 based on respective data chunks extracted from the set of alternative drives 704M, and stores the alternative data chunk 702 jointly with the target data chunk 402 on the target drive 404T. Alternatively, in some embodiments, the second drive 704T generates the alternative data chunk 702 based on respective data chunks extracted from the set of alternative drives 704M, and stores the alternative data chunk 702 on the second drive 704T, separately from the target data chunk 402, which is generated by and stored on the target drive 404T.

FIGS. 8A and 8B are block diagrams of an example memory system 400 that generates integrity data (e.g., a parity data chunk 802), in accordance with some embodiments. In some embodiments, the memory system 400 builds a parity data chunk 802 locally during the course of storing a data stripe 416. A host device 220 writes a set of data chunks 414 corresponding to user data to a set of member drives 404M (e.g., Drives 0, 1, 3, 5, and N). The host device 220 generates a structured data command 406. The structured data command 406 identifies the parity data chunk 802, the set of member drives 404M having the set of data chunks 414 (e.g., Chunks 0, 1, 2, 3, and M), and a target drive 404T (e.g., Drive 4). The set of data chunks 414 and the parity data chunk 802 belong to the same data stripe 416. The host device 220 sends the structured data command 406 to the target drive 404T. The target drive 404T constructs the parity data chunk 802 based on the set of data chunks 414 extracted from the set of member drives 404M and stores the reconstructed parity data chunk 802 locally.

In other words, in some embodiments, the target data chunk 402 corresponds to a parity data chunk 802, and the respective data chunks 414 extracted from the set of member drives 404M correspond to a plurality of user data chunks. The plurality of user data chunks and the parity data chunk form a data stripe 416. More specifically, when a new data stripe 416 needs to be stored on the memory system 400 in a distributed manner, the host device 220 may generate one or more data write commands 804 to store the respective data chunks 414 in the set of member drives 404M. The host device 220 also generates the structured data command 406 requesting generation of the parity data chunk 802 locally at the target drive 404T. The data write commands 804 and the structured data command 406 are both sent to the memory system 400. The set of member drives 404M write the set of respective data chunks 414 in response to the data write commands 804. The target drive 404T sends at least one data request 410 (e.g., a data read request) to each member drive 404M, which provides the respective data chunk 414 to the target drive 404T, allowing the target drive 404T to generate the parity data chunk 802 locally at the target drive 404T.

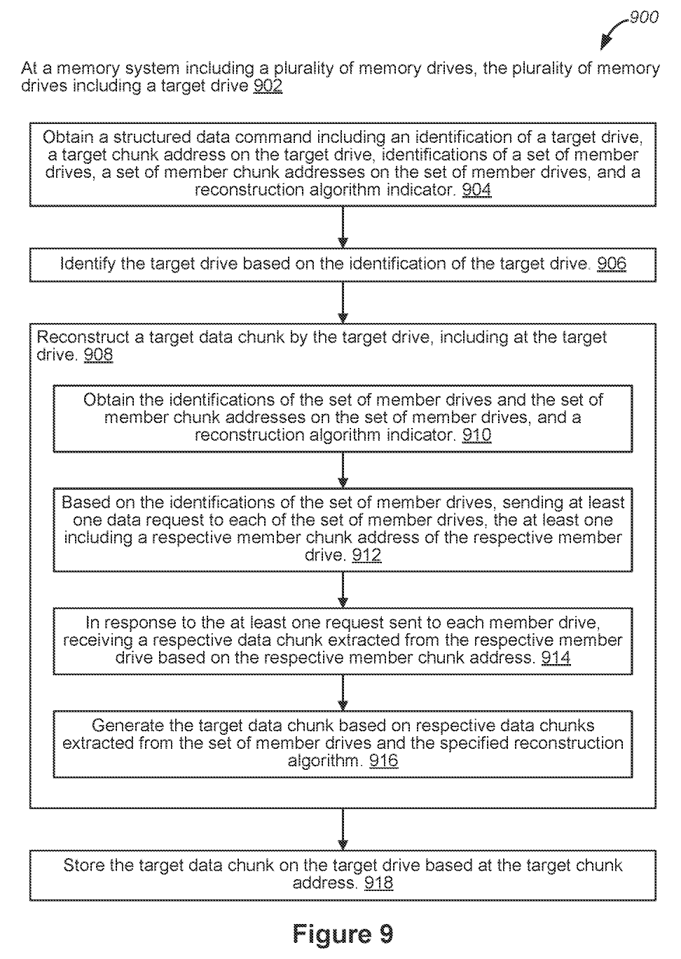

FIG. 9 is a flow diagram of an example method 900 for reconstructing data at a memory system 400, in accordance with some embodiments. The method 900 is implemented (operation 902) by the memory system 400 including a plurality of memory drives 404, and the plurality of memory drives 404 includes a target drive 404T (e.g., in FIGS. 4A and 4B). The memory system 400 obtains (operation 904) a structured data command including an identification of a target drive, a target chunk address on the target drive, identifications of a set of member drives, a set of member chunk addresses on the set of member drives, and a reconstruction algorithm indicator. The memory system 400 identifies (operation 906) the target drive based on the identification of the target drive, and reconstructs (operation 908) a target data chunk by the target drive. More specifically, the target drive 404T obtains (operation 910) the identifications of the set of member drives and the set of member chunk addresses on the set of member drives, and a reconstruction algorithm indicator. Based on the identifications of the set of member drives, the target drive sends (operation 912) at least one data request 410 to each of the set of member drives, e.g., via a peer-to-peer communication channel. The at least one data request 410 includes a respective member chunk address of the respective member drive. In response to the at least one data request 410 sent to each member drive, the target drive receives (operation 914) a respective data chunk extracted from the respective member drive based on the respective member chunk address; and using the designated reconstruction algorithm, and generates (operation 916) the target data chunk based on respective data chunks extracted from the set of member drives, and the specified reconstruction algorithm. The target data chunk is stored (operation 918) on the target drive based at the target chunk address.

FIG. 9 is a flow diagram of an example method 900 for reconstructing data at a memory system 400, in accordance with some embodiments. The method 900 is implemented (operation 902) by the memory system 400 including a plurality of memory drives 404, and the plurality of memory drives 404 include a target drive 404T (e.g., in FIGS. 4A and 4B). The memory system 400 obtains (operation 904) a structured data command 406 including an identification of a target drive 404T, a target chunk address 418T on the target drive 404T, identifications of a set of member drives 404M, a set of member chunk addresses 418M on the set of member drives 404M, and a reconstruction algorithm indicator 612. The memory system 400 identifies (operation 906) the target drive 404T based on the identification of the target drive 404T, and reconstructs (operation 908) a target data chunk 402 by the target drive 404T. More specifically, the target drive 404T obtains (operation 910) the identifications 606 of the set of member drives 404M and the set of member chunk addresses 418M on the set of member drives 404M, and a reconstruction algorithm indicator 612. Based on the identifications 606 of the set of member drives 404M, the target drive 404T sends (operation 912) at least one data request 410 to each of the set of member drives 404M, e.g., via a peer-to-peer communication channel 412. The at least one data request 410 includes a respective member chunk address of the respective member drive. In response to the at least one data request 410 sent to each member drive, the target drive 404T receives (operation 914) a respective data chunk extracted from the respective member drive 404M based on the respective member chunk address; and using the designated reconstruction algorithm, and generates (operation 916) the target data chunk 402 based on respective data chunks 414 extracted from the set of member drives 404M, and the specified reconstruction algorithm. The target data chunk 402 is stored (operation 918) on the target drive 404T based at the target chunk address 418T.

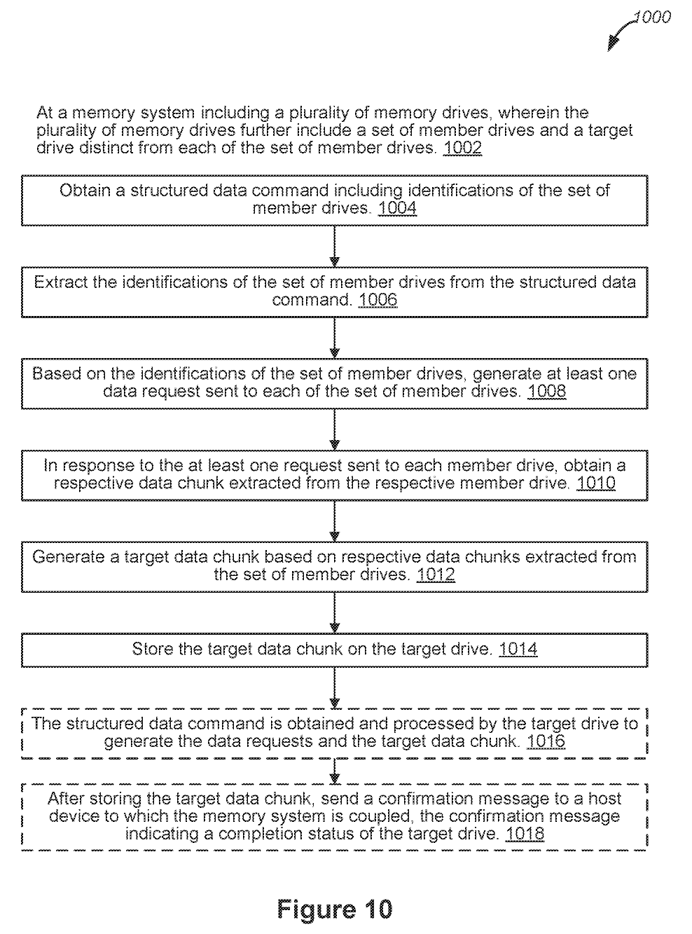

FIG. 10 is a flow diagram of an example method 1000 for reconstructing data at a memory system 400, in accordance with some embodiments. The method 900 is implemented (operation 1002) by the memory system 400 including a plurality of memory drives 404, and the plurality of memory drives 404 includes a set of member drives 404M and a target drive 404T distinct from each of the set of member devices. The memory system 400 obtains (operation 1004) a structured data command 406 including identifications of the set of member drives 404M, and extracts (operation 1006) the identifications of the set of member drives 404M from the structured data command 406. Based on the identifications of the set of member drives 404M, the memory system 400 generates (operation 1008) at least one data request 410 sent to each of the set of member drives 404M. In response to the at least one data request 410 sent to each member drive, the target drive 404T obtains (operation 1010) a respective data chunk extracted from the respective member drive, generates (operation 1012) a target data chunk 402 based on respective data chunks 414 extracted from the set of member drives 404M, and stores (operation 1014) the target data chunk 402 on the target drive 404T.

In some embodiments, the structured data command 406 is obtained and processed (operation 1016) by the target drive 404T to generate the data requests 410 and the target data chunk 402. In some embodiments, the structured data command 406 is obtained and processed (operation 1016) by a system-level controller of the memory system 400 to generate the data requests 410 and the target data chunk 402. In some embodiments, the structured data command 406 is obtained and processed (operation 1016) collaboratively by the target drive 404T and the system-level controller of the memory system 400 to generate the data requests 410 and the target data chunk 402.

In some embodiments, the structured data command 406 further includes an identification of the target drive 404T and a target chunk address 418T on the target drive 404T. The memory system 400 identifies the target drive 404T based on the identification of the target drive 404T. The target data chunk 402 is stored on the target drive 404T based on the target chunk address 418T.

In some embodiments, the structured data command 406 further includes a set of member chunk addresses 418M on the set of member drives 404M. For each of the set of member drives 404M, the at least one data request 410 includes a respective member chunk address of the respective member drive, and the respective data chunk is extracted from the respective member drive 404M based at the respective member chunk address.

In some embodiments (FIGS. 8A and 8B), the target data chunk 402 corresponds to a parity data chunk 802 (e.g., the single parity data chunk in a data stripe, one of multiple parity data chunks in a data stripe), and the respective data chunks 414 extracted from the set of member drives 404M corresponding to a plurality of user data chunks 414, and the plurality of user data chunks 414 and the parity data chunk 802 form a data stripe 416. Further, in some embodiments, the memory system 400 is coupled to a host device 220. The host device 220 generates data write commands 804 to store the respective data chunks 414 in the set of member drives 404M, generates the structured data command 406 requesting generation of the parity data chunk 802 locally at the target drive 404T, and sends the data write commands 804 and the structured data command 406 to the memory system 400.

In some embodiments, the memory system 400 is coupled to a host device 220. The host device 220 determines that data stored on a first drive 404A need to be reconstructed, and the data stored on the first drive 404A includes the target data chunk 402 and an alternative data chunk 702. The host device 220 generates the structured data command 406 for reconstructing the target data chunk 402 and an alternative data command 706 for reconstructing the alternative data chunk 702. Further, in some embodiments, the target drive 404T obtains the alternative data command 706 including identifications of a set of alternative drives 704M, generates an alternative data chunk 702 based on respective data chunks 414 extracted from the set of alternative drives 704M, and stores the alternative data chunk 702 on the target drive 404T. Alternatively, in some embodiments, a second drive 704T is distinct from the target drive 404T. The second drive 704T obtains the alternative data command 706 including identifications of a set of alternative drives 704M, generates an alternative data chunk 702 based on respective data chunks 414 extracted from the set of alternative drives 704M, and stores the alternative data chunk 702 on the second drive 704T.

In some embodiments, the structured data command 406 includes one or more of: a data length 610 of the target data chunk 402, a reconstruction algorithm indicator 612 for generating the target data chunk 402, and a number 614 of member drives associated with the target data chunk 402.

In some embodiments, after storing the target data chunk 402, the target drive 404T sends (operation 1018) a confirmation message 504 to a host device 220 to which the memory system 400 is coupled, and the confirmation message 504 indicates a completion status of the target drive 404T.

In some embodiments, the target data chunk 402 is selected from Reed-Solomon error-correction codes, Hamming error-correction codes, Low-density parity-check (LDPC) codes, and XOR-based error-correction codes.

In some embodiments, the respective data chunk of one of the set of member drives 404M is selected from Reed-Solomon error-correction codes, Hamming error-correction codes, Low-density parity-check (LDPC) codes, and XOR-based error-correction codes, and the target data chunk 402 includes a subset of user data applied to generate the respective data chunk 414 of the one of the set of member drives 404M.

In some embodiments, the plurality of memory drives 404 are communicatively coupled to one another via a Peripheral Component Interconnect Express (PCIe) bus, and the target drive 404T receives the respective data chunk 414 extracted from each respective member drive 404M via the PCIe bus without involving a host device 220.

In some embodiments, the memory system 400 is coupled to a host device 220 and configured to communicate with the host device 220 via a PCIe bus 502 (FIG. 2), and the structured data command 406 is received from the host device 220 via the PCIe bus 502 in compliance with a Non-Volatile Memory Express (NVMe) or NVMe over fabrics (NVMeOF) protocol.

In some embodiments, each of the plurality of memory drives 404 has an interface selected from Small Computer System Interface (SCSI), a Serial Storage Architecture (SSA) interface, a Fibre Channel interface, an Internet SCSI (iSCSI) interface, and a Serial-Attached SCSI (SAS) interface.

In some embodiments, respective data chunks 414 of the set of member drives 404M and the target data chunk 402 of the target drive 404T are arranged according to a redundant array of independent disks (RAID) scheme selected from RAID1, RAID3, RAID5, RAID6, RAID-N, RAID10, RAID50, and RAID60.

In some embodiments, the target drive 404T determines that an error has occurred while receiving the respective data chunks 414 extracted from the set of member drives 404M or generating the target data chunk 402, generates an error alert message 506 (FIG. 5) based on the error, and sends the error alert message 506 to a host device 220 that issues the structured data command 406. The error alert message 506 may not be a separate message. Instead, the error alert message 506 may be included in a confirmation message 504 returned to the host device 220 in response to the structured data command 406 to recover the target data chunk 402. The host device 220 is configured to fetch the respective data chunks 414 from the set of member drives 404M, generate the target data chunk 402 based on the respective data chunks 414, and send a write request 508 to the target drive 404T to store the target data chunk 402.

In some embodiments, the memory system 400 is coupled to a host device 220. The host device 220 determines that data stored on a first drive 404A need to be reconstructed, and the data stored on the first drive 404A includes the target data chunk 402 and an alternative data chunk 702. The host device 220 generates the structured data command 406 for reconstructing the target data chunk 402 and an alternative data command 706 for the alternative data chunk 702.

In some embodiments (FIG. 7B), the structured data command 406 includes identifications of a set of alternative drives 704M. The target drive 404T generates an alternative data chunk 702 based on respective data chunks 714 extracted from the set of alternative drives 704M and stores the alternative data chunk 702 on the target drive 404T. Alternatively, in some embodiments (FIG. 7B), a second drive 704T is distinct from the target drive 404T. The second drive 704T generates an alternative data chunk 702’ based on respective data chunks 714 extracted from the set of alternative drives 704M and stores the alternative data chunk 702’ on the second drive 704T.

In some embodiments, each memory drive 404 includes a respective solid-state drive (SSD), and the respective SSD includes a plurality of NAND flash memory cells.

Some implementations of this application are directed to sharing memory (e.g., DRAM and SRAM) between memory storage and compute functions dynamically, e.g., using established NVMe protocol semantics to share memory from a host. In some embodiments, an isolated NAND namespace used for Linux paging file, and a pathway is accelerated due to a shared memory architecture. Data may be moved into and out of a shared L3 cache using memcpy. In some embodiments, a memory device operates in a single level cell (SLC) mode, when the shared memory architecture is applied.

Memory is also used to store instructions and data associated with the method 900, and includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory, optionally, includes one or more storage devices remotely located from one or more processing units. Memory, or alternatively the non-volatile memory within memory, includes a non-transitory computer readable storage medium. In some embodiments, memory, or the non-transitory computer readable storage medium of memory, stores the programs, modules, and data structures, or a subset or superset for implementing method 900.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, the memory, optionally, stores a subset of the modules and data structures identified above. Furthermore, the memory, optionally, stores additional modules and data structures not described above.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Additionally, it will be understood that, although the terms “first,” “second,” etc. may be used herein to describe various elements, these elements should not be limited by these terms. These terms are only used to distinguish one element from another.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof.

What is claimed is:

1. A method for memory data reconstruction, comprising:
at a memory system including a plurality of memory drives, wherein the plurality of memory drives further include a set of member drives and a target drive distinct from each of the set of member drives:
obtaining a structured data command including identifications of the set of member drives;
extracting the identifications of the set of member drives from the structured data command;
based on the identifications of the set of member drives, generating at least one data request sent to each of the set of member drives ;
in response to the at least one data request sent to each member drive, obtaining a respective data chunk extracted from the respective member drive; and
generating a target data chunk based on respective data chunks extracted from the set of member drives; and
storing the target data chunk on the target drive.

2. The method of claim 1, wherein the structured data command further includes an identification of the target drive and a target chunk address on the target drive, and the method further comprises:
identifying the target drive based on the identification of the target drive, wherein the target data chunk is stored on the target drive based on the target chunk address.

3. The method of claim 1, wherein:
the structured data command further includes a set of member chunk addresses on the set of member drives; and
for each of the set of member drives, the at least one data request includes a respective member chunk address of the respective member drive, and the respective data chunk is extracted from the respective member drive based at the respective member chunk address.

4. The method of claim 1, wherein the target data chunk corresponds to a parity data chunk, and the respective data chunks extracted from the set of member drives correspond to a plurality of user data chunks, the plurality of user data chunks and the parity data chunk forming a data stripe.

5. The method of claim 4, wherein the memory system is coupled to a host device, further comprising, at the host device:
generating data write commands to store the respective data chunks in the set of member drives;
generating the structured data command requesting generation of the parity data chunk locally at the target drive; and
sending the data write commands and the structured data command to the memory system.

6. The method of claim 1, wherein the memory system is coupled to a host device, further comprising, at the host device:
determining that data stored on a first drive need to be reconstructed, wherein the data stored on the first drive includes the target data chunk and an alternative data chunk; and
generating the structured data command for reconstructing the target data chunk and an alternative data command for reconstructing the alternative data chunk.

7. The method of claim 6, further comprising, at the target drive:
obtaining the alternative data command including identifications of a set of alternative drives; generating an alternative data chunk based on respective data chunks extracted from the set of alternative drives; and
storing the alternative data chunk on the target drive.

8. The method of claim 6, further comprising, at a second drive distinct from the target drive:
obtaining the alternative data command including identifications of a set of alternative drives;
generating an alternative data chunk based on respective data chunks extracted from the set of alternative drives; and
storing the alternative data chunk on the second drive.

9. The method of claim 1, wherein the structured data command includes one or more of: a data length of the target data chunk, a reconstruction algorithm indicator for generating the target data chunk, and a number of member drives associated with the target data chunk.

10. The method of claim 1, further comprising, at the target drive:
after storing the target data chunk, sending a confirmation message to a host device to which the memory system is coupled, the confirmation message indicating a completion status of the target drive.

11. The method of claim 1, wherein the memory system is coupled to a host device, and the structured data command includes identifications of a set of alternative drives, the method further comprising:
at the host device:
determining that data stored on a first drive need to be reconstructed, the data stored on the first drive including the target data chunk and an alternative data chunk; and
generating the structured data command for reconstructing the target data chunk and an alternative data command for the alternative data chunk; and
at the target drive or a second drive distinct from the target drive:
generating an alternative data chunk based on respective data chunks extracted from the set of alternative drives; and
storing the alternative data chunk on the target drive or the second drive.

12. A memory system, comprising:
a plurality of memory drives including set of member drives and a target drive distinct from each of the set of member drives;
one or more processors; and
memory having instructions stored thereon, which when executed by the one or more processors cause the processors to perform:
obtaining a structured data command including identifications of the set of member drives;
extracting the identifications of the set of member drives from the structured data command;
based on the identifications of the set of member drives, generating at least one data request sent to each of the set of member drives ;
in response to the at least one data request sent to each member drive, obtaining a respective data chunk extracted from the respective member drive; and
generating a target data chunk based on respective data chunks extracted from the set of member drives; and
storing the target data chunk on the target drive.

13. The memory system of claim 12, wherein the memory system is coupled to a host device and configured to communicate with the host device via a PCIe bus, and the structured data command is received from the host device via the PCIe bus in compliance with a Non-Volatile Memory Express (NVMe) or NVMe over fabrics (NVMeOF) protocol.

14. The memory system of claim 12, wherein each of the plurality of memory drives has an interface selected from Small Computer System Interface (SCSI), a Serial Storage Architecture (SSA) interface, a Fibre Channel interface, an Internet SCSI (iSCSI) interface, and a Serial-Attached SCSI (SAS) interface.

15. The memory system of claim 12, wherein respective data chunks of the set of member drives and the target data chunk of the target drive are arranged according to a redundant array of independent disks (RAID) scheme selected from RAID1, RAID3, RAID5, RAID6, RAID-N, RAID10, RAID50, and RAID60, and each memory drive includes a respective solid-state drive (SSD), and the respective SSD includes a plurality of NAND flash memory cells.

16. A non-transitory computer-readable storage medium, having instructions stored thereon, which when executed by one or more processors cause the processors to perform:
at a memory system including a plurality of memory drives, wherein the plurality of memory drives further include a set of member drives and a target drive distinct from each of the set of member drives:
obtaining a structured data command including identifications of the set of member drives;
extracting the identifications of the set of member drives from the structured data command;
based on the identifications of the set of member drives, generating at least one data request sent to each of the set of member drives ;
in response to the at least one data request sent to each member drive, obtaining a respective data chunk extracted from the respective member drive; and
generating a target data chunk based on respective data chunks extracted from the set of member drives; and
storing the target data chunk on the target drive.

17. The non-transitory computer-readable storage medium of claim 16, further comprising instructions for, at the target drive:
determining that an error has occurred during receiving the respective data chunks extracted from the set of member drives or generating the target data chunk;
generating an error alert message based on the error; and
sending the error alert message to a host device that issues the structured data command;
wherein the host device is configured to fetch the respective data chunks from the set of member drives, generate the target data chunk based on the respective data chunks, and send a write request to the target drive to store the target data chunk.

18. The non-transitory computer-readable storage medium of claim 16, wherein the target data chunk is selected from Reed-Solomon error codes, Hamming error codes, Low-density parity-check (LDPC) codes, and XOR-based error codes.

19. The non-transitory computer-readable storage medium of claim 16, wherein the respective data chunk of one of the set of member drives is selected from Reed-Solomon error codes, Hamming error codes, LDPC codes, and XOR-based error codes, and the target data chunk includes a subset of user data applied to generate the respective data chunk of the one of the set of member drives.

20. The non-transitory computer-readable storage medium of claim 16, wherein the plurality of memory drives are communicatively coupled to one another via a Peripheral Component Interconnect Express (PCIe) bus, and the target drive receives the respective data chunk extracted from each respective member drive via the PCIe bus without involving a host device.
